(19) United States
(12) Patent Application Publication
(10) Pub. No.: US 2021/0088153 A1
(43) Pub. Date: Mar. 25, 2021

(54) SOLENOID VALVE

(71) Applicant: DENSO CORPORATION, Kariya-city (JP)

(72) Inventor: Masamichi WATANABE, Kariya-city (JP)

(21) Appl. No.: 17/084,826

(22) Filed: Oct. 30, 2020

Related U.S. Application Data
(63) Continuation of application No. PCT/JP2019/019278, filed on May 15, 2019.

(30) Foreign Application Priority Data
May 16, 2018 (JP) 2018-094334

(51) Int. Cl. F16K 31/06; F16K 11/07

(52) U.S. Cl. CPC F16K 31/0613; F16K 11/0716; F16K 31/0675

(57) ABSTRACT

A spool has: a first continuously displaced portion formed such that a clearance between an inner peripheral surface of a receiving member and the first continuously displaced portion is continuously reduced from one side of the first continuously displaced portion toward another side of the first continuously displaced portion; and a second continuously displaced portion formed such that a clearance between the inner peripheral surface of the receiving member and the second continuously displaced portion is continuously reduced from one side of the second continuously displaced portion toward another side of the second continuously displaced portion. An annular groove is formed between a first small diameter end of the first continuously displaced portion located at the one side of the first continuously displaced portion and a second small diameter end of the second continuously displaced portion located at the one side of the second continuously displaced portion.

### CROSS REFERENCE TO RELATED APPLICATIONS

This application is a continuation application of International Patent Application No. PCT/JP2019/019278 filed on May 15, 2019, which designated the U.S. and claims the benefit of priority from Japanese Patent Application No. 2018-94334 filed on May 16, 2018. The entire disclosures of all of the above applications are incorporated herein by reference.

### TECHNICAL FIELD

The present disclosure relates to a solenoid valve.

### BACKGROUND

Previously, there has been proposed a solenoid valve, in which a land of a spool includes: a tapered portion that has an outer diameter, which increases from a high pressure port side toward a low pressure port side; a small diameter portion that has an outer diameter, which is equal to the outer diameter of one end of the tapered portion located on the high pressure port side; and a large diameter portion that has an outer diameter, which is equal to the outer diameter of another end of the tapered portion located on the low pressure port side.

### SUMMARY

This section provides a general summary of the disclosure, and is not a comprehensive disclosure of its full scope or all of its features.

According to the present disclosure, there is provided a solenoid valve that includes a spool and a solenoid device. The spool is received in a receiving member such that the spool is slidable along an inner peripheral surface of the receiving member. The spool has: a first continuously displaced portion that is formed at an outer peripheral surface of a corresponding one of a plurality of lands of the spool such that a clearance between the inner peripheral surface of the receiving member and the first continuously displaced portion is continuously reduced from one side of the first continuously displaced portion toward another side of the first continuously displaced portion; and a second continuously displaced portion that is formed at an outer peripheral surface of a corresponding one of the plurality of lands such that a clearance between the inner peripheral surface of the receiving member and the second continuously displaced portion is continuously reduced from one side of the second continuously displaced portion toward another side of the second continuously displaced portion. At least one annular groove is formed between a first small diameter end, which is an end of the first continuously displaced portion located at the one side of the first continuously displaced portion, and a second small diameter end, which is an end of the second continuously displaced portion located at the one side of the second continuously displaced portion, while a diameter of a groove bottom of the at least one annular groove is smaller than an outer diameter of the first small diameter end and an outer diameter of the second small diameter end.

### BRIEF DESCRIPTION OF DRAWINGS

The drawings described herein are for illustrative purposes only of selected embodiments and not all possible implementations, and are not intended to limit the scope of the present disclosure.

FIG. 1 is a diagram showing an overall structure of a solenoid valve according to a first embodiment.

FIG. 2 is a schematic cross-sectional view of the solenoid valve according to the first embodiment.

FIG. 3 is a characteristic diagram showing a relationship between the displacement amount of a tapered portion and a leakage flow rate.

FIG. 4 is a schematic cross-sectional view of a solenoid valve according to a second embodiment.

FIG. 5A is a schematic cross-sectional view of a solenoid valve according to a third embodiment.

FIG. 5B is an enlarged view of a portion Vb in FIG. 5A.

FIG. 6 is a schematic cross-sectional view of a solenoid valve according to a fourth embodiment.

FIG. 7 is a schematic cross-sectional view of a solenoid valve according to a fifth embodiment.

FIG. 8 is a schematic cross-sectional view of a solenoid valve according to a sixth embodiment.

FIG. 9 is a schematic cross-sectional view of a solenoid valve of a comparative example.

### DETAILED DESCRIPTION

Previously, as a technique with respect to a solenoid valve configured to move a spool through movement of a plunger in response to electric current supplied to a coil, there is known a technique for forming a portion of an outer peripheral surface of the spool in a tapered form. For example, at least one land of a spool of a solenoid valve of a previously proposed technique includes: a tapered portion that has an outer diameter, which increases from a high pressure port side toward a low pressure port side; a small diameter portion that has an outer diameter, which is equal to the outer diameter of one end of the tapered portion located on the high pressure port side; and a large diameter portion that has an outer diameter, which is equal to the outer diameter of another end of the tapered portion located on the low pressure port side. According to this technique, the outer diameter of the tapered portion increases from a supply port (serving as the high pressure port) side toward a feedback port (serving as the low pressure port) side.

The previously proposed technique intends to enable easy measurement of the outer diameter of the small diameter portion and the outer diameter of the large diameter portion, and a sufficient straight length, which is sufficient to place a measurement tool along it, needs to be provided at each of the small diameter portion and the large diameter portion. Thus, in a case where another tapered portion is also formed to extend from the supply port side toward an output port, which is located on an opposite side of the supply port that is opposite to the feedback port, a length of the small diameter portion needs to be increased at a valley that corresponds to the supply port, and thereby a size of the solenoid valve is increased. Therefore, it is not realistic to have the structure, in which the multiple tapered portions are placed adjacent to each other in an axial direction.

As a result, it is not possible to provide the tapered portion, which extends from the supply port side toward the output port side. Thus, a clearance of a flow passage, which extends from the supply port side toward the output port side, is increased, and thereby a flow rate of fluid passing through this flow passage is increased. Furthermore, due to the increase in the flow rate, a fluid force, which interferes with a slide resistance reduced by the tapered portion located on the feedback port side, is generated, so that the spool will likely become eccentric to the sleeve. When the eccentricity amount of the spool is increased, a leakage flow rate (leak flow rate) of the fluid, which passes through the clearance in a valve closing state, is disadvantageously increased.

Furthermore, according to the previously proposed technique, an angle of a boundary portion between the tapered portion and the small diameter portion is less than 180 degrees. Thus, when a general-purpose cutting tool or grindstone is used in a cutting or grinding process for processing the outer diameter of the tapered portion, the boundary portion interferes with the general-purpose cutting tool or grindstone. Therefore, a dedicated cutting tool or grindstone, which is adjusted in conformity with the angle of the boundary portion, is required. Thus, a shape variation becomes large due to, for example, wear of the cutting tool or grindstone during mass production, and a dimensional control becomes difficult.

A solenoid valve of the present disclosure is configured to control a flow rate of fluid by opening or closing a corresponding one or more of a plurality of ports, which are formed at a receiving member, with a corresponding one or more of a plurality of lands of a spool by reciprocating the spool at an inside of the receiving member through movement of a plunger, which is configured to be magnetically attracted in response to electric current supplied to a coil. The receiving member may be a sleeve of the solenoid valve or may be a valve body that is an installation subject, to which the solenoid valve is installed.

This solenoid valve includes the spool and a solenoid device. The spool is received in the receiving member such that the spool is slidable along an inner peripheral surface of the receiving member that has the following ports: a supply port, which is configured to receive a supply of the fluid; an output port, which is located on one side of the supply port and is configured to output the fluid having a pressure that is lower than a pressure of the fluid at the supply port; and a feedback port, which is located on another side of the supply port that is opposite to the output port, while the feedback port is configured to receive the fluid having a pressure that is substantially equal to the pressure of the fluid at the output port. Specifically, the supply port is a relatively high pressure side port, and the output port and the feedback port are relatively low pressure side ports.

The solenoid device includes the coil and the plunger and is configured to drive the spool through the movement of the plunger at a time of energizing the coil.

The spool has: a first continuously displaced portion that is formed at an outer peripheral surface of a corresponding one of the plurality of lands such that a clearance between the inner peripheral surface of the receiving member and the first continuously displaced portion is continuously reduced from one side of the first continuously displaced portion, at which the supply port is placed, toward another side of the first continuously displaced portion, at which the output port is placed; and a second continuously displaced portion that is formed at an outer peripheral surface of a corresponding one of the plurality of lands such that a clearance between the inner peripheral surface of the receiving member and the second continuously displaced portion is continuously reduced from one side of the second continuously displaced portion, at which the supply port is placed, toward another side of the second continuously displaced portion, at which the feedback port is placed. Here, the continuously displaced portion may take a form that has an outer diameter, which linearly changes in an axial cross-section thereof, and this form of the continuously displaced portion corresponds to a tapered portion. Besides this form, the continuously displaced portion may take another form that has an outer diameter, which changes in a curved fashion (changes along a curve) in an axial cross section thereof.

At least one annular groove is formed between a first small diameter end, which is an end of the first continuously displaced portion located at the one side of the first continuously displaced portion where the supply port is placed, and a second small diameter end, which is an end of the second continuously displaced portion located at the one side of the second continuously displaced portion where the supply port is placed, while a diameter of a groove bottom of the at least one annular groove is smaller than an outer diameter of the first small diameter end and an outer diameter of the second small diameter end.

In the solenoid valve of the present disclosure, the first continuously displaced portion, which extends toward the output port, and the second continuously displaced portion, which extends toward the feedback port, are respectively formed at two opposite sides of the supply port. Therefore, in the solenoid valve of the present disclosure, the flow rate of the fluid on the output port side can be reduced in comparison to the previously proposed technique. By using both of the continuously displaced portions, the slide resistance can be limited in good balance to reduce the eccentricity. Thereby, the leakage flow rate, which is induced by the eccentricity, can be limited. Furthermore, by appropriately setting the displacement amount, a total flow rate, which includes the leakage flow rate caused by the clearance, can be appropriately limited.

Furthermore, in the solenoid valve of the present disclosure, the annular groove is formed between the first small diameter end and the second small diameter end, so that it is possible to release the cutting tool or the grindstone at the small diameter end at the time of processing the outer diameter of the tapered portion. Therefore, the general-purpose cutting tool or grindstone can be used, and thereby the dimensional control is eased during the mass production.

Hereinafter, a plurality of embodiments of a solenoid valve will be described with reference to the drawings. In the plurality of embodiments, the substantially same structural portions are denoted by the same reference signs, and the description thereof will be omitted. Furthermore, the first to sixth embodiments may be respectively referred to as “present embodiment.” The present embodiment is about a solenoid valve of a spool type that is applied to, for example, a hydraulic system of an automatic transmission and controls a flow rate of hydraulic oil (serving as fluid). The solenoid valve of the first to fourth embodiments is a normally closed type, and the solenoid valve of the fifth embodiment is a normally open type. In the sixth embodiment, there is exemplified a form of the solenoid valve, in which a spool is directly inserted in a valve body.

### First Embodiment

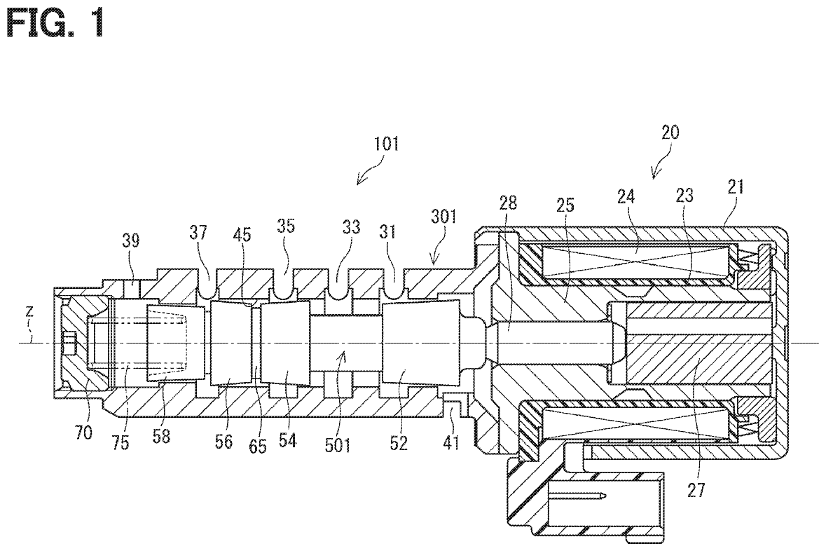

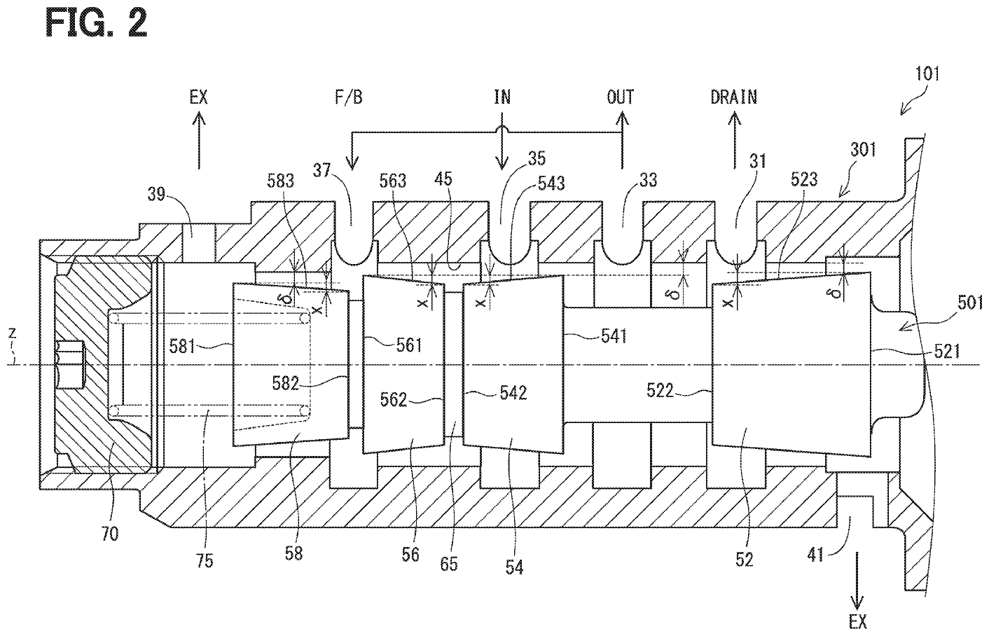

The first embodiment will be described with reference to FIGS. 1 to 3. FIGS. 1 and 2 show a non-energized state of a coil 24. First of all, an overall structure of the solenoid valve 101 will be described with reference to FIG. 1. The solenoid valve 101 is configured to reciprocate a spool 501 at an inside of a sleeve 301, which serves as a receiving member, through movement of a plunger 27, which is configured to be magnetically attracted in response to electric current supplied to the coil 24. Thereby, a flow rate of the hydraulic oil is controlled by opening or closing a corresponding one or more of a plurality of ports, which are formed at the sleeve 301, with a corresponding one or more of a plurality of lands of the spool 501.

In the solenoid valve 101, the sleeve 301, the spool 501 and a solenoid device 20 are coaxially arranged along a central axis Z. However, in reality, a slight eccentricity of the order of several μm may occur between the sleeve 301 and the spool 501, so it is interpreted that the term “coaxial” implies to include a slight eccentricity. The eccentricity will be described later.

The solenoid device 20 includes a case 21, the coil 24, a core 25, the plunger 27 and a shaft 28. In the coil 24, a conductive wire, which is coated with a dielectric film, is wound around a bobbin 23 made of a resin material. The case 21, the core 25 and the plunger 27 are made of a magnetic material. When the coil 24 is energized, a magnetic flux flows in a magnetic circuit that extends through the case 21, the core 25 and the plunger 27. The plunger 27 is magnetically attracted to the core 25 in response to the electric current that is supplied to the coil 24.

When the plunger 27 is moved by the magnetic attractive force of the core 25, a drive force of the plunger 27 is transmitted to the spool 501 through the shaft 28. A load of a spring 75, which is supported by a plug 70, is urged against an end part of the spool 501, which is opposite to the shaft 28. When the magnetic attractive force of the core 25 becomes larger than the urging load of the spring 75, the spool 501 is moved toward the plug 70. As discussed above, the solenoid device 20 drives the spool 501 through the movement of the plunger 27 at the time of energizing the coil 24. Hereinafter, a moving direction of the spool 501 will be referred to as an axial direction.

Next, structures of the sleeve 301 and the spool 501 in the solenoid valve 101 of the normally closed type of the first embodiment will be described with reference to FIG. 2. The sleeve 301 is shaped in a tubular form, and a drain port 31, an output port 33, a supply port 35, a feedback port 37 and a discharge port 39, which extend through an outer wall and an inner wall of the sleeve 301, are arranged in this order from the solenoid device 20 side in the axial direction. Furthermore, another discharge port 41 is formed on the solenoid device 20 side of the drain port 31. In FIG. 2, “DRAIN”, “OUT”, “IN”, “F/B” and “EX” are respectively indicated at the drain port 31, the output port 33, the supply port 35, the feedback port 37 and the discharge ports 39, 41.

Hereinafter, with respect to the pressure of the hydraulic oil, “high pressure” and “low pressure” do not mean an absolute pressure range, but “relatively high pressure” and “relatively low pressure.” A lower limit of the low pressure is equivalent to the atmospheric pressure. Further, the term “always” means “regardless of the electric current supplied to the coil 24” or “regardless of the valve opening/closing degree implemented by the position of the spool 501.”

The hydraulic oil always having the high pressure is supplied from the outside to the supply port 35. The output port 33 is located on one side of the supply port 35 and is configured to output the hydraulic oil having a pressure, which is lower than the pressure of the hydraulic oil at the supply port 35. The feedback port 37 is located on another side of the supply port 35 that is opposite to the output port 33, while the feedback port 37 is configured to receive the hydraulic oil having a pressure that is substantially equal to the pressure of the hydraulic oil at the output port 33. The pressure of the hydraulic oil at the output port 33 and the pressure of the hydraulic oil at the feedback port 37 are variably controlled in a range, which is from the low pressure to a relatively high pressure that is lower than the pressure of the hydraulic oil at the supply port 35, in accordance with the electric current supplied to the coil 24.

Specifically, with respect to the relationship among the three ports 33, 35, 37, which are formed at the axial center portion of the sleeve 301, the supply port 35 is a relatively high pressure side port, and the output port 33 and the feedback port 37 are relatively low pressure side ports.

Next, the drain port 31 and the discharge ports 39, 41 will be described. The drain port 31 is located on a side of the output port 33, which is opposite to the supply port 35, and the drain port 31 discharges the hydraulic oil, which always has a pressure that is equivalent to the atmospheric pressure and is lower than the pressure of the hydraulic oil at the output port 33. Similarly, the discharge port 41, which is located on the solenoid device 20 side of the drain port 31 that is opposite to the output port 33, discharges the hydraulic oil, which always has the pressure that is equivalent to the atmospheric pressure. The discharge port 39, which is located on the plug 70 side, is located on a side of the feedback port 37, which is opposite to the supply port 35, and the discharge port 39 discharges the hydraulic oil, which always has the pressure that is equivalent to the atmospheric pressure and is lower than the pressure of the hydraulic oil at the feedback port 37.

Specifically, with respect to the relationship between the output port 33 and the drain port 31, the output port 33 is a relatively high pressure side port, and the drain port 31 is a relatively low pressure side port. With respect to the relationship between the feedback port 37 and the discharge port 39, the feedback port 37 is a relatively high pressure side port, and the discharge port 39 is a relatively low pressure side port.

The spool 501 is inserted in the sleeve 301 such that the spool 501 is slidable along an inner peripheral surface 45 of the sleeve 301. With respect to a radial clearance between the spool 501 and the sleeve 301, a radial clearance δ and a displacement amount (amount of displacement) x of the respective tapered portions described later are actually in the μm order. Therefore, when the radial clearance δ and the displacement amount x of the respective tapered portions are indicated at the actual scale, the radial clearance δ and the displacement amount x of the respective tapered portions overlap along a single line and are difficult to show the configuration thereof. Because of this reason, the radial clearance δ and the displacement amount x of the respective tapered portions are exaggerated in FIG. 2. In the description of the action of blocking the flow passage at the valve closing time, it is desirable to understand the exaggerated clearance is several tens of μm.

The spool 501 has a plurality of lands 52, 54, 56, 58, which are slidable along the inner peripheral surface 45 of the sleeve 301. For convenience of explanation, an ordinal prefix is added to the name of the respective lands starting from the land located at the axial center. The first land 54 is configured to open or close a communication from the supply port 35 to the output port 33. The second land 56 is configured to open or close a communication from the supply port 35 to the feedback port 37. The third land 52 is configured to open or close a communication from the output port 33 to the drain port 31. The fourth land 58 is configured to open or close a communication from the feedback port 37 to the discharge port 39.

At a non-energizing time of the coil 24, in which the coil 24 is not energized, the spool 501 is located at a position shown in FIG. 2 where the communication between the supply port 35 and the output port 33 is blocked, thereby implementing the normally closed structure. In contrast, at an energizing time of the coil 24, in which the coil 24 is energized, the spool 501 is moved toward the plug 70, and thereby the supply port 35 and the output port 33 are communicated with each other. Since this operation of the solenoid valve is a known technique, description of details of this operation is omitted for the sake of simplicity.

Tapered portions 523, 543, 563, 583 are respectively formed at outer peripheral surfaces of the lands 52, 54, 56, 58 such that a clearance between each of the tapered portions 523, 543, 563, 583 and the inner peripheral surface 45 of the sleeve 301 is continuously reduced from one side of the tapered portion 523, 543, 563, 583, at which the corresponding relatively high pressure side port is placed, toward another side of the tapered portion 523, 543, 563, 583, at which the corresponding relatively low pressure side port is placed. The term “tapered portion” refers to a specific form of the continuously displaced portion, i.e., a specific form that has an outer diameter, which linearly changes in an axial cross-section thereof, while the term “the continuously displaced portion” serves as a broader, more generic term. Hereinafter, “the continuously reducing the clearance between the tapered portion and the inner peripheral surface of the sleeve” will be also simply rephrased as “increasing the diameter of the tapered portion”.

A large diameter side end of each tapered portion will be referred to as a large diameter end, and a small diameter side end of each tapered portion will be referred to as a small diameter end. Each tapered portion, each large diameter end and each small diameter end are given an ordinal prefix of a corresponding one of “first” to “fourth” in conformity with the names of the corresponding lands.

The first land 54 has the first tapered portion 543, which has a diameter that increases from the supply port 35 side toward the output port 33 side, i.e., increases from the first small diameter end 542 to the first large diameter end 541 of the first tapered portion 543. The second land 56 has the second tapered portion 563, which has a diameter that increases from the supply port 35 side toward the feedback port 37 side, i.e., increases from the second small diameter end 562 to the second large diameter end 561 of the second tapered portion 563.

The third land 52 has the third tapered portion 523, which has a diameter that increases from the output port 33 side toward the drain port 31 side, i.e., increases from the third small diameter end 522 to the third large diameter end 521 of the third tapered portion 523. The fourth land 58 has the fourth tapered portion 583, which has a diameter that increases from the feedback port 37 side toward the discharge port 39 side, i.e., increases from the fourth small diameter end 582 to the fourth large diameter end 581 of the fourth tapered portion 583.

Therefore, as a whole, the supply port 35 serves as an axial center, and the diameter of the outer peripheral surface of each land 52, 54, 56, 58 increases from the axial center side toward the corresponding one of the two opposite axial ends. Furthermore, the first small diameter end 542, which is the end of the first tapered portion 543 located on the supply port 35 side, is opposed to the second small diameter end 562, which is the end of the second tapered portion 563 located on the supply port 35 side, so that the first tapered portion 543 and the second tapered portion 563 form a V-shape configuration. Additionally, an annular groove 65 is formed between the first small diameter end 542 and the second small diameter end 562 while a diameter of a groove bottom of the annular groove 65 is smaller than the outer diameter of the first small diameter end 542 and the outer diameter of the second small diameter end 562.

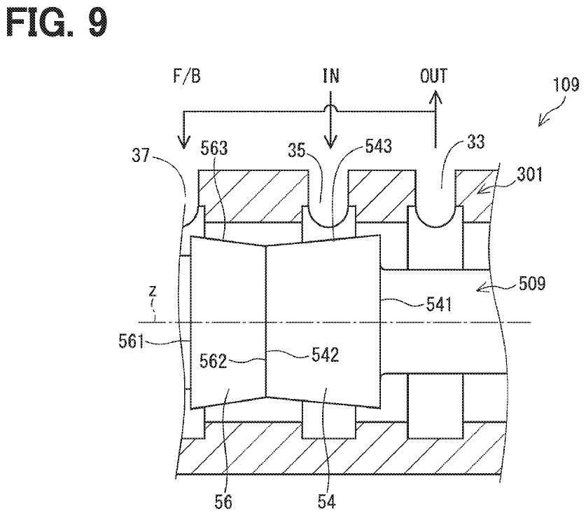

In a solenoid valve 109 of a comparative example shown in FIG. 9, a spool 509 does not have the annular groove described above, and thereby the first small diameter end 542 and the second small diameter end 562 are directly joined with each other. In the case of this configuration, when a general-purpose cutting tool or grindstone is used in cutting or grinding process for processing the outer diameter of the tapered portion, the boundary portion, which is formed in the V-shape, interferes with the general-purpose cutting tool or grindstone. Therefore, a dedicated cutting tool or grindstone, which is adjusted in conformity with the V-shape angle of the boundary portion, is required. Therefore, a shape variation becomes large due to, for example, wear of the cutting tool or grindstone during mass production, and a dimensional control becomes difficult.

In view of the above point, the annular groove 65 is formed between the first small diameter end 542 and the second small diameter end 562, so that it is possible to release the cutting tool or the grindstone at the small diameter end 542, 562 at the time of processing the outer diameter of the tapered portion 543, 563. Therefore, the general-purpose cutting tool or grindstone can be used, and thereby the dimensional control is eased during the mass production.

Next, referring back to FIG. 2, “the displacement amount” will be described by using the first tapered portion 543 as an example. With respect to “the displacement amount,” the other tapered portions are similar to the first tapered portion 543. In the first tapered portion 543, a difference between a radius of the first large diameter end 541 and a radius of the first small diameter end 542 is defined as “the displacement amount x.” The displacement amount x corresponds to one half of a difference between an outer diameter of the large diameter end and an outer diameter of the small diameter end. Furthermore, a difference between a radius of the inner peripheral surface 45 of the sleeve 301 and the radius of the first large diameter end 541 will be defined as “a radial clearance δ.” The radial clearance δ corresponds to one half of a difference between an inner diameter of the inner peripheral surface 45 and the outer diameter of the first large diameter end 541.

Here, the flow rate Q of the hydraulic oil, which flows in the annular gap, is expressed by the following equation 1. The symbols in the equation 1 have the following meanings.

D: sleeve outer diameter

δ: radial clearance

L: seal length

ΔP: differential pressure

μ: oil viscosity

e: the eccentricity amount

$$Q = \frac{π D {δ}^{3}}{12 μ L} Δ P ( 1 + \frac{3}{2} {( \frac{e}{δ} )}^{2} ) \qquad [ Equation 1 ]$$

In the equation 1, when it is assumed that D, L, μ and ΔP are constant, the flow rate Q is increased when the radial clearance δ is increased or when the eccentricity amount (amount of eccentricity) e is increased. Furthermore, when it is assumed that the outer peripheral surface of the spool 501 contacts the inner peripheral surface of the sleeve 302 at the time of occurrence of the maximum eccentricity between the spool 501 and the sleeve 302, the eccentricity amount e coincides with the radial clearance δ, i.e., (e/δ)=1. Therefore, because of {1+(3/2)×1}=2.5, the flow rate Q at the time of occurrence of maximum eccentricity is increased by 2.5 times in comparison to the time when the eccentricity amount e=0.

In the present embodiment, by forming the tapered portions 543, 563 at the outer peripheral surfaces of at least the first land 54 and the second land 56, the pressure of the hydraulic oil is uniformly exerted in the circumferential direction, and thereby a centering effect, which limits the eccentricity, is achieved. Thus, the centering effect, which is implemented by the tapered portions 543, 563 and the like, contributes in a reduction in the eccentricity amount e and a reduction in the flow rate Q. In contrast, at the small diameter end 542, 562 side of the tapered portion 543, 563, the radial clearance δ is disadvantageously increased to disadvantageously increase the flow rate Q.

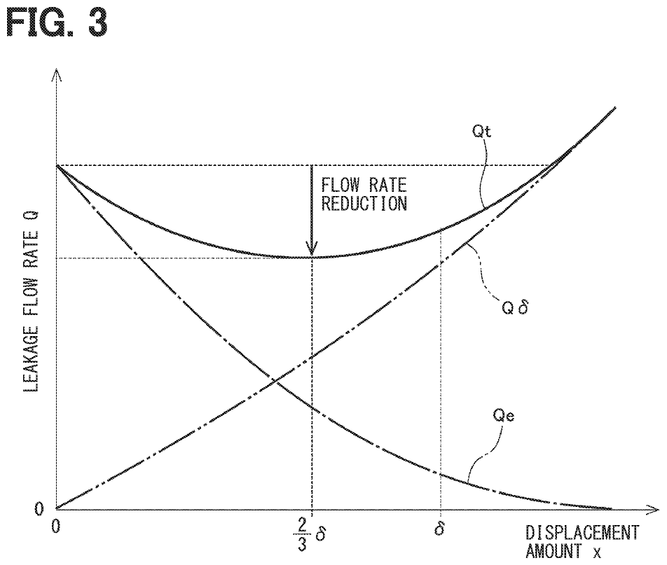

Therefore, it is thought that there is an optimum value, which is neither too small nor too large, exists for the displacement amount x of the tapered portion 543, 563. In view of this point, FIG. 3 shows a result of a simulation with respect to the relationship between the displacement amount x of the tapered portion and the flow rate Q. In FIG. 3, a dot-dash line indicates a flow rate Qe influenced by the eccentricity, and a dot-dot-dash line indicates a flow rate Qδ influenced by the radial clearance. A solid line indicates a total flow rate Qt, which is a sum of the flow rate Qe influenced by the eccentricity and the flow rate Qδ influenced by the radial clearance.

Here, it is assumed that the eccentricity is generated in a case where the tapered portion is not provided, and thereby the displacement amount x is zero, and it is also assumed that the eccentricity is reduced in a case where the tapered portion is provided, and thereby the displacement amount x is set to be larger than 0 μm. Then, the flow rate Qe, which is influenced by the eccentricity, is reduced when the displacement amount x is increased. In contrast, the flow rate Qδ, which is influenced by the radial clearance, is increased when the displacement amount x is increased. Therefore, the total flow rate Qt is represented by a U-shaped curve that has a minimum value. According to the simulation, the total flow rate Qt is minimized at the time of satisfying “the displacement amount x=(2/3)×radial clearance δ.”

Based on this analysis, in the first embodiment, the displacement amount x of the tapered portion 543, 563 is set to be about two thirds of the radial clearance δ at the corresponding location. As discussed above, according to the first embodiment, the eccentricity of the spool 501 is reduced, and the leakage flow rate of the annular gap can be reduced by the clearance portion.

The advantages of the present disclosure will be described in comparison to the previously proposed technique discussed above. The solenoid valve of the previously propose technique discussed above is common with the present embodiment in that the tapered portion, which has the diameter that increases from the high pressure port side toward the low pressure port side, is formed at the outer peripheral surface of the land. However, according to this technique, it is required that the small diameter portion, which has the corresponding constant outer diameter, and the large diameter portion, which has the corresponding constant outer diameter, are integrally formed at two opposite ends of the tapered portion. Thus, in consideration of avoiding an increase in a size of the solenoid valve, it is not realistic to form an additional tapered portion, which extends from the supply port side toward the output port side in addition to the tapered portion, which extends from the supply port side toward the feedback port side. Furthermore, the dedicated cutting tool or grindstone is required in the process for processing the outer diameter of the boundary portion between the tapered portion and the small diameter portion, and the dimensional control is difficult during the mass production.

In comparison to this previously proposed technique, according to the present embodiment, the first tapered portion 543, which extends toward the output port 33, and the second tapered portion 563, which extends toward the feedback port 37, are respectively formed at the two opposite sides of the supply port 35. Therefore, it is possible to reduce the flow rate of the hydraulic oil, which flows toward the output port 33, in comparison to the previously propose technique discussed above. Furthermore, the slide resistance can be limited in good balance by the tapered portions 543, 563, and the eccentricity can be reduced. Furthermore, by forming the annular groove 65 as described above, the dimensional control is eased during the mass production.

Furthermore, another previously proposed technique discloses a solenoid valve that has a plurality of flow-blocking portions, which are arranged in series and are formed between outer peripheral surfaces of lands of a spool and an inner peripheral surface of a sleeve hole while the flow-blocking portions have an overlap length that corresponds to a moving position of the spool. This solenoid valve addresses an objective of limiting a waste flow rate caused by leakage like the present embodiment. However, in the above-described configuration, the plurality of flow-blocking portions having the overlap length is provided. Therefore, with the conventional processing accuracy, variations become large, and high processing accuracy is required. Furthermore, the waste flow rate is limited by increasing the overlap, so that the responsiveness of the solenoid valve is disadvantageously deteriorated. In comparison to this previously proposed technique, according to the present embodiment, the eccentricity is reduced without requiring the lengthening of the overlap or reducing of the clearance, and the waste flow rate and/or the slide resistance can be limited.

### Second Embodiment

In each of the second and subsequent embodiments, the reference sign of the solenoid valve is indicated by three digits while the initial two digits are 10, and the last third digit shows the embodiment number. Also, in each of the second and subsequent embodiments, the reference sign of the sleeve is indicated by three digits while the initial two digits are 30, and the last third digit shows the embodiment number, and the reference sign of the spool is indicated by three digits while the initial two digits are 50, and the last third digit shows the embodiment number. Furthermore, in a case where the structure of sleeve and/or the structure of the spool are the same as those of the preceding embodiment, the same reference sign(s) as the reference sign(s) used in the preceding embodiment is/are used for the sleeve and/or the spool. In the sixth embodiment, a valve body, which is a receiving member used in place of the sleeve, is indicated by a reference sign “306.” In a schematic cross-sectional view of the drawing of each of the following embodiments, the displacement of the respective tapered portions and the radial clearances are indicated with the exaggeration like in FIG. 2.

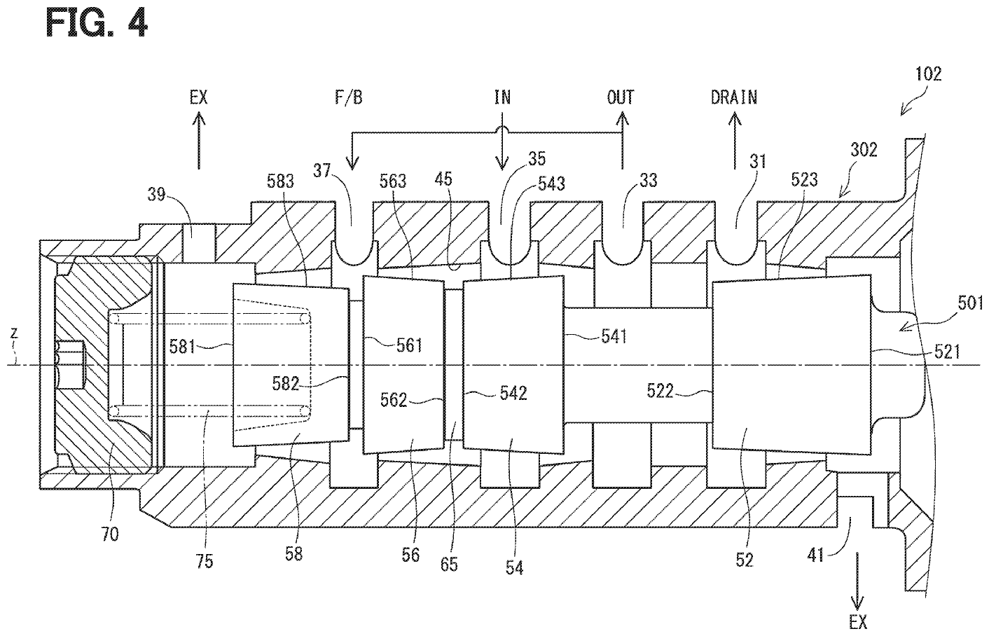

The solenoid valve 102 of the second embodiment will be described with reference to FIG. 4. In the solenoid valve 102, in addition to the tapered portions formed at the outer peripheral surface of the spool 501, tapered portions are also formed at the inner peripheral surface of the sleeve 302. With respect to each clearance radially formed by the corresponding tapered portion of the spool 501 and the corresponding tapered portion of the sleeve 302, the corresponding tapered portion of the spool 501 and the corresponding tapered portion of the sleeve 302 are formed such that the clearance is continuously reduced from one side, at which the corresponding high pressure side port is placed, toward another side, at which the corresponding low pressure side port is placed.

Another previously proposed technique discloses a solenoid valve, in which a tapered portion is formed only at an inner peripheral surface of a sleeve such that an inner diameter of the tapered portion is reduced from a high pressure side port toward a low pressure side port. However, it is difficult to ensure required processing accuracy of the inner peripheral surface of the sleeve, and the inner diameter accuracy may possibly be deteriorated.

In comparison to this previously proposed technique, according to the second embodiment, the tapered portions 543, 563 and the like, which serve as main tapered portions, are formed at the outer peripheral surface of the spool 501, and tapered portions, which serve as auxiliary tapered portions, are also formed at the inner peripheral surface of the sleeve 302. Good processing accuracy can be ensured at the spool 501 side, so that even if the processing accuracy of the sleeve 302 is low to some extent, the overall effect is small. Therefore, advantages, which are similar to those of the first embodiment, can be achieved.

### Third Embodiment

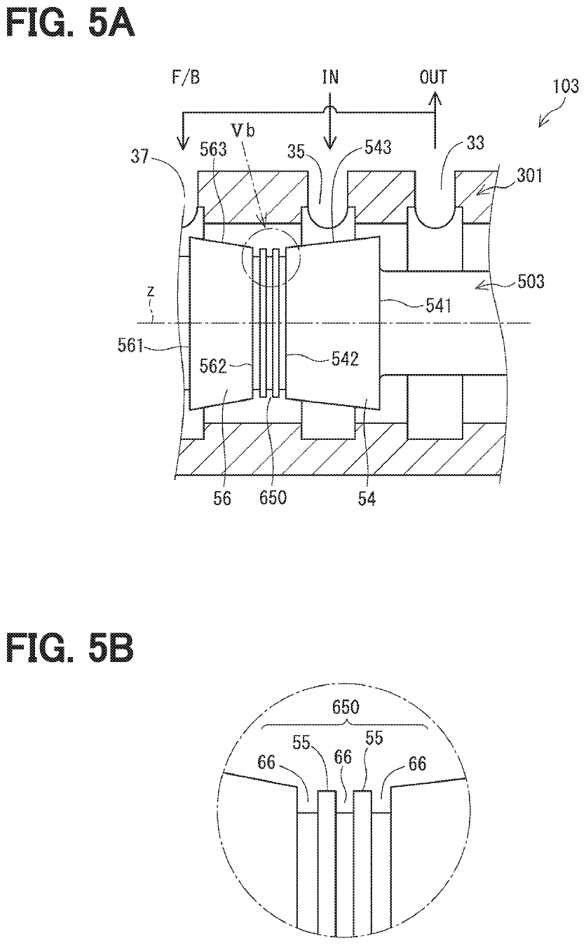

The solenoid valve 103 of the third embodiment will be described with reference to FIGS. 5A and 5B. The spool 503 of the solenoid valve 103 has a complex groove portion 650, which includes a plurality of annular grooves 66 and at least one ridge 55 and is formed between the first small diameter end 542 of the first tapered portion 543 and the second small diameter end 562 of the second tapered portion 563 in place of the single annular groove 65. Each of the ridges 55 has an outer diameter that is larger than a diameter of a groove bottom of each of the annular grooves 66. The plurality of annular grooves 66 is formed such that each ridge 55 is interposed in the axial direction between corresponding adjacent two of the annular grooves 66.

Specifically, an axial position and the outer diameter of each ridge 55 are set such that the ridge 55 does not interfere with the general-purpose cutting tool or grindstone at the time of processing the outer diameter of the tapered portion 543, 563. Therefore, like in the first embodiment, the outer diameter of the tapered portion can be processed with the general-purpose cutting tool or grindstone, and the quality control is eased during the mass production. Furthermore, by providing the ridge(s) 55, a size of a cross-sectional area of the flow passage can be adjusted to appropriately limit the flow rate.

### Fourth Embodiment

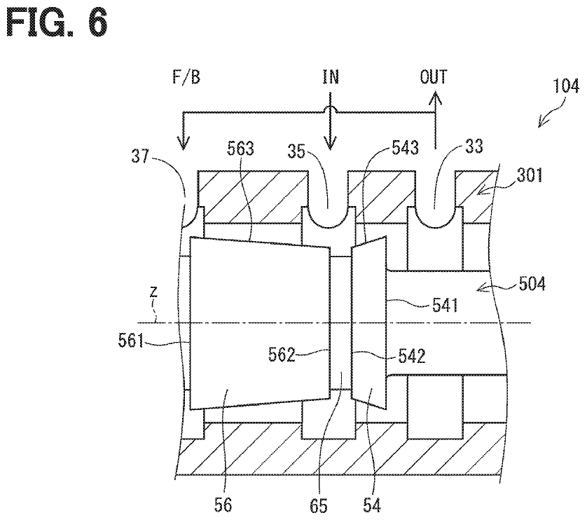

The solenoid valve 104 of the fourth embodiment shown in FIG. 6 differs from the first to third embodiments with respect to the axial positions of the first land 54, the second land 56 and the annular groove 65 of the spool 504. Specifically, at the non-energizing time of the coil 24, the annular groove 65 is placed at a position that is immediately below the supply port 35 rather than the position immediately below the slide surface located between the supply port 35 and the feedback port 37. Even with this configuration, advantages, which are similar to those of the first embodiment, can be achieved.

### Fifth Embodiment

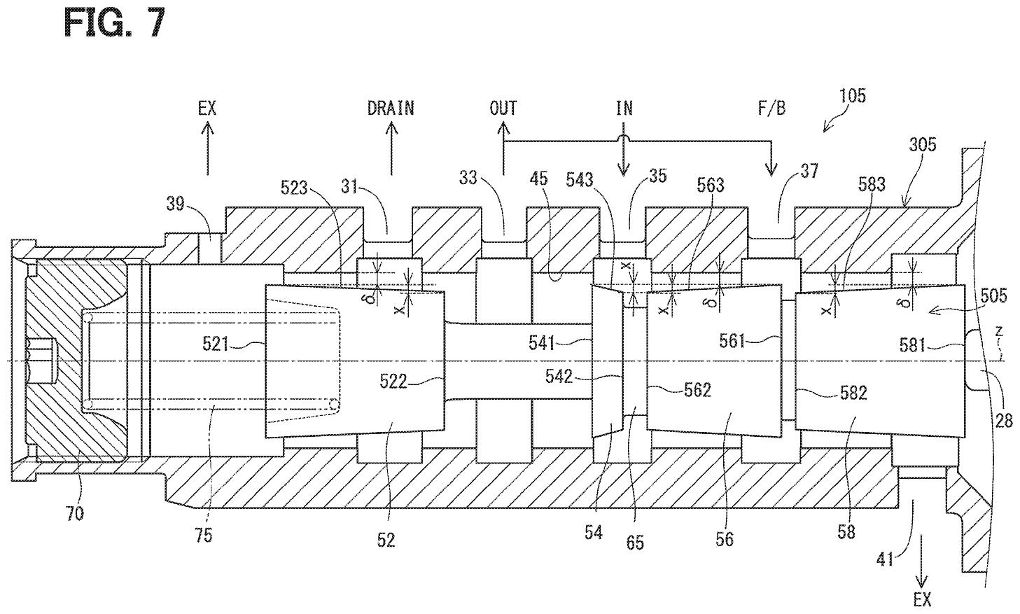

The solenoid valve 105 of the fifth embodiment shown in FIG. 7 is a solenoid valve of a normally open type. The sleeve 305 has the feedback port 37, the supply port 35, the output port 33, the drain port 31 and the discharge port 39, which are arranged in this order from the solenoid device 20 side toward the plug 70 side. Furthermore, the other discharge port 41 is located on the solenoid device 20 side of the feedback port 37.

At the non-energizing time of the coil 24, the spool 505 is located at a position shown in FIG. 7 where the supply port 35 and the output port 33 are communicated with each other, thereby implementing the normally open structure. In contrast, at the energizing time of the coil 24, the spool 505 is moved toward the plug 70, and thereby the communication between the supply port 35 and the output port 33 is blocked.

Even with this configuration, the first land 54 of the spool 505 has the first tapered portion 543, which has the diameter that increases from the supply port 35 side toward the output port 33 side, and the second land 56 of the spool 505 has the second tapered portion 563, which has the diameter that increases from the supply port 35 side toward the feedback port 37 side. Furthermore, the annular groove 65 is formed between the first small diameter end 542 of the first tapered portion 543 and the second small diameter end 562 of the second tapered portion 563. Furthermore, the third land 52 of the spool 505 has the third tapered portion 523, which has the diameter that increases from the output port 33 side toward the drain port 31 side, and the fourth land 58 of the spool 505 has the fourth tapered portion 583, which has the diameter that increases from the feedback port 37 side toward the discharge port 41 side.

With this configuration, the solenoid valve of the normally open type of the fifth embodiment can achieve advantages, which are similar to those of the first embodiment. The configuration of the tapered portions of the inner peripheral surface of the sleeve of the second embodiment and/or the configuration of the plurality of annular grooves of the third embodiment may be combined with the solenoid valve of the fifth embodiment.

### Sixth Embodiment

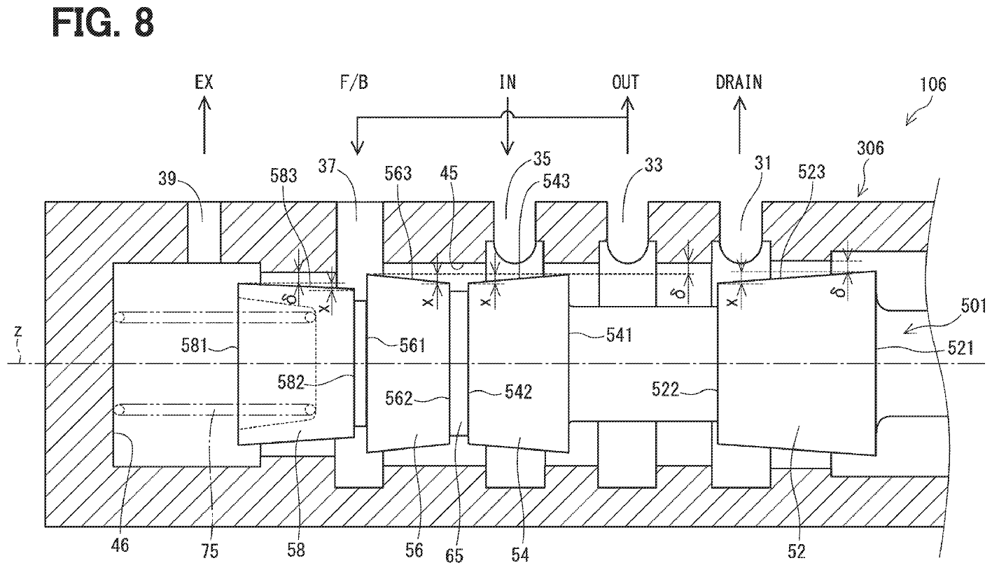

The solenoid valve 106 of the sixth embodiment shown in FIG. 8 is configured such that the spool 501, which is similar to the spool 501 of the first embodiment, is directly inserted into the valve body 306 of the automatic transmission that is the installation subject, to which the solenoid valve 106 is installed. In the sixth embodiment, the valve body 306 serves as the receiving member. As discussed above, the receiving member is not necessarily limited to the sleeve of the solenoid valve and may be in any other form of the receiving member, which has the plurality of ports and receives the spool 501 such that the spool 501 is reciprocatable.

### Other Embodiments

(a) In the above-described embodiments, the four tapered portions, i.e., the first tapered portion 543, the second tapered portion 563, the third tapered portion 523 and the fourth tapered portion 583 are formed at the outer peripheral surface of the spool 501 or the like. In another embodiment, it may be only required that at least the first tapered portion 543 and the second tapered portion 563 are formed. Specifically, whether or not the third tapered portion 523 and/or the fourth tapered portion 583 are further formed can be arbitrarily decided.

(b) In the above-described embodiments, the tapered portions, each of which has the outer diameter that linearly changes in the axial cross-section thereof, are formed as the continuously displaced portions of the outer peripheral surface of the spool. In another embodiment, the continuously displaced portion(s) may take another form that has an outer diameter, which changes in a curved fashion (changes along a curve) in an axial cross section thereof.

(c) The solenoid valve of the present disclosure is not necessarily limited to the valve that controls the flow rate of the hydraulic oil of the automatic transmission, and the solenoid valve of the present disclosure may be applied as a valve that controls an ordinary flow rate of fluid in another system.

As described above, the present disclosure is not necessarily limited to the above-described embodiments, and the present disclosure may be implemented in various forms without departing from the spirit of the present disclosure.

The present disclosure has been described in view of the embodiments. However, the present disclosure is not limited to the embodiments and structures described above. The present disclosure also includes various modifications and changes within an equivalent range. Further, various combinations and forms, and other combinations and forms including only one element, more, or less than those described above are also within the scope and spirit of the present disclosure.

1. A solenoid valve configured to control a flow rate of fluid by opening or closing a corresponding one or more of a plurality of ports, which are formed at a receiving member, with a corresponding one or more of a plurality of lands of a spool by reciprocating the spool at an inside of the receiving member through movement of a plunger, which is configured to be magnetically attracted in response to electric current supplied to a coil, the solenoid valve comprising:
the spool that is received in the receiving member such that the spool is slidable along an inner peripheral surface of the receiving member, wherein the receiving member has:
a supply port, which is configured to receive a supply of the fluid;
an output port, which is located on one side of the supply port and is configured to output the fluid having a pressure that is lower than a pressure of the fluid at the supply port; and
a feedback port, which is located on another side of the supply port that is opposite to the output port, while the feedback port is configured to receive the fluid having a pressure that is substantially equal to the pressure of the fluid at the output port; and
a solenoid device that includes the coil and the plunger and is configured to drive the spool through the movement of the plunger at a time of energizing the coil, wherein:
the spool has:
a first continuously displaced portion that is formed at an outer peripheral surface of a corresponding one of the plurality of lands such that a clearance between the inner peripheral surface of the receiving member and the first continuously displaced portion is continuously reduced from one side of the first continuously displaced portion, at which the supply port is placed, toward another side of the first continuously displaced portion, at which the output port is placed; and
a second continuously displaced portion that is formed at an outer peripheral surface of a corresponding one of the plurality of lands such that a clearance between the inner peripheral surface of the receiving member and the second continuously displaced portion is continuously reduced from one side of the second continuously displaced portion, at which the supply port is placed, toward another side of the second continuously displaced portion, at which the feedback port is placed; and
at least one annular groove is formed between a first small diameter end, which is an end of the first continuously displaced portion located at the one side of the first continuously displaced portion where the supply port is placed, and a second small diameter end, which is an end of the second continuously displaced portion located at the one side of the second continuously displaced portion where the supply port is placed, while a diameter of a groove bottom of the at least one annular groove is smaller than an outer diameter of the first small diameter end and an outer diameter of the second small diameter end.

2. The solenoid valve according to claim 1, wherein:
the receiving member has a drain port that is located on one side of the output port, which is opposite to the supply port, while the drain port is configured to drain the fluid having a pressure lower than the pressure of the fluid at the output port; and
the spool has a third continuously displaced portion that is formed at an outer peripheral surface of a corresponding one of the plurality of lands such that a clearance between the inner peripheral surface of the receiving member and the third continuously displaced portion is continuously reduced from one side of the third continuously displaced portion, at which the output port is placed, toward another side of the third continuously displaced portion, at which the drain port is placed.

3. The solenoid valve according to claim 2, wherein:
the receiving member has a discharge port that is located on one side of the feedback port, which is opposite to the supply port, while the discharge port is configured to discharge the fluid having a pressure lower than the pressure of the fluid at the feedback port; and
the spool has a fourth continuously displaced portion that is formed at an outer peripheral surface of a corresponding one of the plurality of lands such that a clearance between the inner peripheral surface of the receiving member and the fourth continuously displaced portion is continuously reduced from one side of the fourth continuously displaced portion, at which the feedback port is placed, toward another side of the fourth continuously displaced portion, at which the discharge port is placed.

4. The solenoid valve according to claim 1, wherein the at least one annular groove is a plurality of annular grooves while at least one ridge, which has an outer diameter larger than the diameter of the groove bottom of each of the plurality of annular grooves, is interposed between each adjacent two of the plurality of annular grooves in an axial direction.
